(19) United States
(12) Patent Application Publication
(10) Pub. No.: US 2003/0216934 A1
(43) Pub. Date: Nov. 20, 2003

(54) Operating method for a communication network and apparatus for implementing the operating method

(76) Inventor: Thomas Pfoertner, Hoehenkirchen (DE)

Correspondence Address: Bell, Boyd & Lloyd LLC, P.O. Box 1135, Chicago, IL, 60690, US

(21) Appl. No.: 10/406,884

(22) Filed: Apr. 4, 2003

(30) Foreign Application Priority Data
Apr. 4, 2002 (DE) 102 14 928.3

(51) Int. Cl. G06F 17/60

(52) U.S. Cl. 705/1; 705/412; 705/34

(57) ABSTRACT

An operating method for a communication network to provide a chargeable service, in which service costs are subsequently billed and an estimated cost value is calculated in a service control center of the communication network on the basis of prestored tariff data. The estimated cost value is compared with a credit value and provision of the service is triggered or blocked in response to a verification signal signifying the result of the comparison.

### BACKGROUND

The present invention relates to an operating method for a communication network, such as a fixed telephone network or mobile telephone network, for example and an arrangement or network structure that is appropriate for implementing this method.

With the current transformation processes taking place in companies when they are changed from industrial to information and service companies, expanding the possible uses of communication networks becomes important. This transformation requires significant investment in the infrastructure, which operators have been making for some years now. As a result, companies have undertaken a significant financial burden and are forced to implement both consistent and effective risk control and limitation on the revenue side for this and other reasons.

Extension of the range of offerings of telecommunication providers to include data services and above all content and applications and the higher level of integration of external content suppliers achieved by opening up the premium rate services (0190, 0900) mean, on the one hand, that the payment risk increases significantly with regard to volume and risk class, and, on the other hand, that it turns into a collection risk. This has a considerable economic impact on the telecommunication companies.

A greater level of attention, therefore, has to be paid to the management of these risks. According to current perceptions, this requires a fundamental review of accounting processes.

In conventional accounting processes, telecommunication services are generally charged in the form of three sub-processes, which are implemented with differing degrees of frequency:

(1) recording of service usage in the switching point or other network elements by generating and storing usage records (at least once per service usage, e.g., telephone call),

(2) recording of these and calculation with the tariff and assignment to a customer account (at least once a month, sometimes more frequently), and

(3) billing and monitoring of payments received (usually monthly).

Based on typical payment and reminder schedules, this means a risk of at least two monthly sales figures for the operator.

This risk can, for example, be reduced by calculating the account balances at shorter intervals (meaning more frequent implementation of sub-process (2) and comparing them with customer-specific limits, or the “discretionary limits”, determined on the basis of a credit check on the customers.

The more this risk reduction is implemented (i.e., the shorter the update cycles for account balances) the greater the cost of changes to the accounting system, to the point that complete replacement is necessary. This is associated with high investment costs in the new system and high migration costs and risks, as all existing customer and tariff data has to be transferred to the new system and any system failure may lead to a failure to collect. Ultimately there are high operating costs, as all the data relating to the charging system has to be processed using the more expensive new system.

### SUMMARY

An operating method is disclosed for use in a communication network, which provides chargeable service to a subscriber by a network connection assigned to the subscriber. In the network, service costs are subsequently billed through use of the collective invoice produced for a specific period of service usage at the network connection with the invoice covering a number of individual services. The method includes receiving a record sent by a communication terminal connected to the network connection that specifies a selective service. An estimated cost value is then calculated based on prestored tariff data in response to receiving the record. The estimated cost is then compared with the total value and the verification signal issued that signifies a result of comparing the estimated cost with the credit value. Finally, the method includes at least one of blocking the triggering position of the selective service in response to the verification signal.

An apparatus is also disclosed for providing a chargeable service to a subscriber of a communication network via network connection assigned to the subscriber. The apparatus includes a calculation unit configured to calculate an estimated cost value. The calculation unit is connected to a tariff database configured to store communication network tariff data. Additionally, a credit value storage unit is included that stores a credit value assigned to the network connection. The comparison unit connected to the calculation unit and the credit value storage unit is provided to compare the estimated cost value of the credit value and to emit a verification signal as a result of the comparison. A service control unit connected to an output of the comparison unit is provided to one of trigger or block the chargeable service based on the corresponding status of the verification signal, the chargeable service being assigned to a service control center.

### BRIEF DESCRIPTION OF THE DRAWINGS

FIG. 1 illustrates a (multi-part) flow chart of a conventional accounting process for telecommunication services.

FIG. 2 illustrates a diagram based on FIG. 1 to show an accounting process modified according to the present disclosure.

FIG. 3 illustrates a simplified flow chart of an RT payment process according to the present disclosure.

FIG. 4 illustrates an outline of an arrangement according to the present disclosure.

FIG. 5 illustrates a function block circuit diagram of an arrangement for implementing the disclosed method.

### DETAILED DESCRIPTION OF THE PREFERRED EXAMPLES

The disclosed method and arrangement provide an improved operating method for a communication network associated with lower costs and migration risks than the previously known methods, with which payment and collection risks can be significantly reduced.

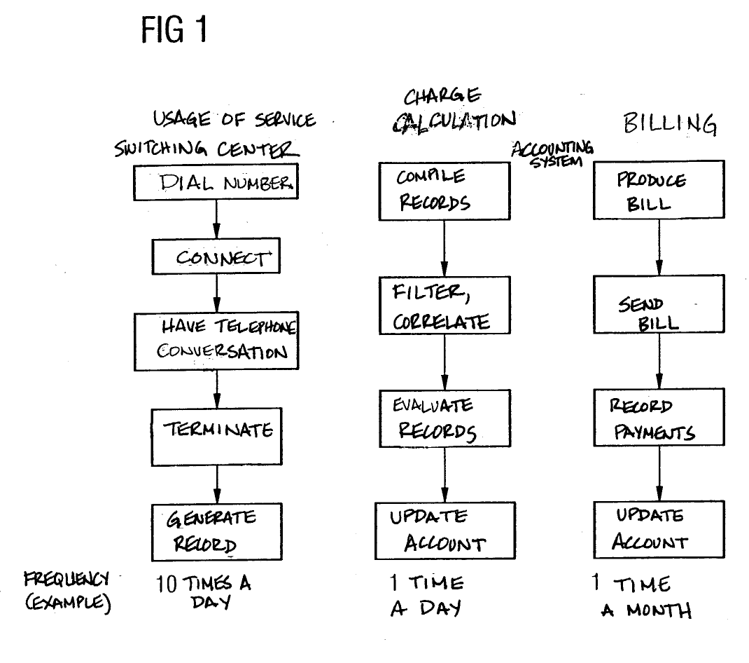

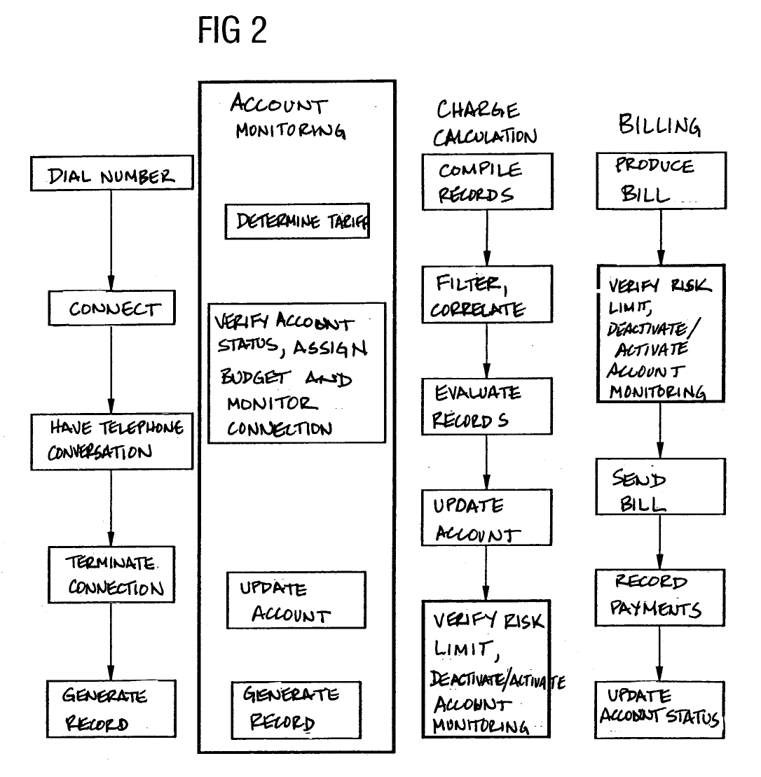

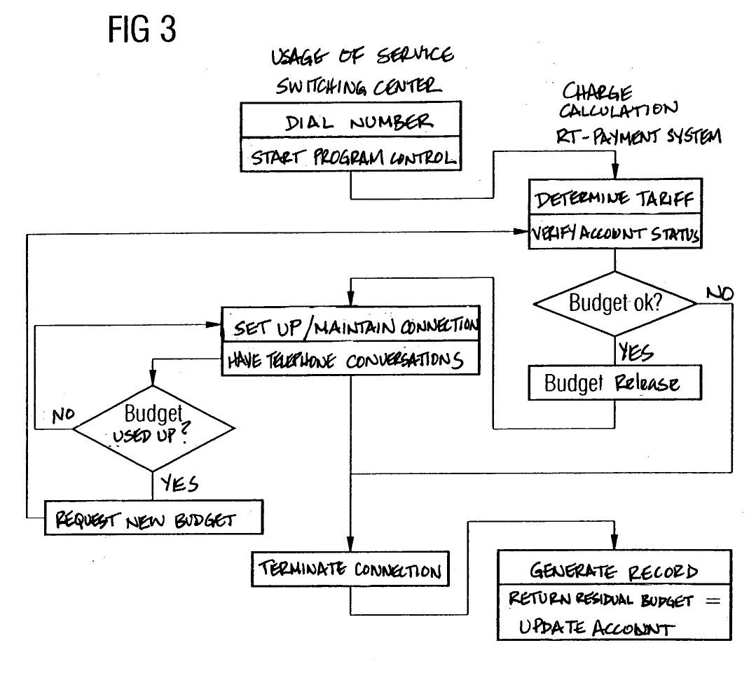

FIGS. 1 to 3 are essentially self-explanatory due to the labeling and taking into account the above general descriptions of the proposed method, so no further verbal description is given here.

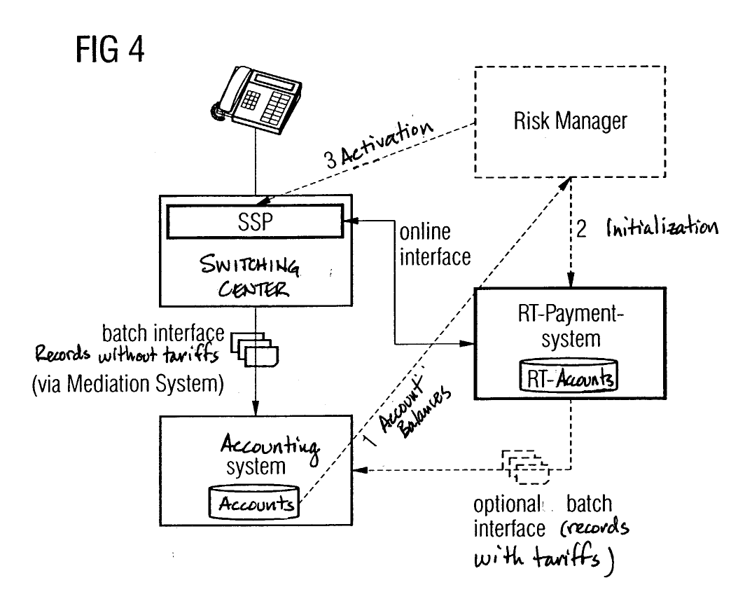

FIG. 4 shows a synoptic diagram of an exemplary system structure and the subprocesses (1) account balances, (2) initialization, and (3) activation of the RT payment system. According to this diagram, overall process control here is managed by a server or application, designated here as the risk manager. The application is implemented centrally in a telecommunication network, to which the terminal shown as an example in the figure is connected and to which the switching center and service switching point SSP belong. The conventional accounting system and the RT payment system are shown here as relatively independent functionalities, in each instance with assigned separate account databases. It is, however, clear from the above embodiments that the RT payment system overlies the conventional billing system and extends it in a customer-specific fashion.

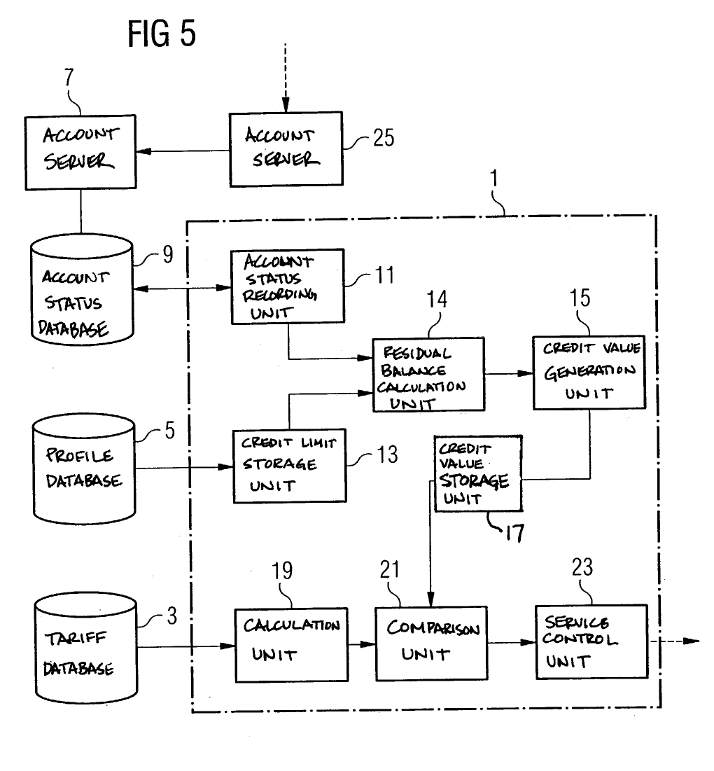

FIG. 5 is a function block circuit diagram showing the functional units of an RT payment arrangement 1 for implementing the presently disclosed method. The arrangement includes a tariff database 3 of the relevant communication network (not shown), a user profile database 5 for storing subscriber records, which contain, for example, data representing a credit limit value, and an account status database 9 assigned to an account server 7.

The individual sub-processes and sub-stages of a conventional accounting method for services provided via the telecommunication network operate on the account server 7 with access to the account status database. The account status database 9, however, also provides the updated account statuses of those subscribers for whom the RT payment arrangement 1 is currently being applied.

The arrangement 1 has an account status recording unit 11 to monitor the respective account statuses, and a credit limit storage unit 13 connected in the form of an arrangement-specific buffer to the user profile database 5, forming a credit value generation unit 15 together with the account status recording unit 11 and a residual balance calculation unit 14, to calculate the credit values applicable to the users managed with the arrangement 1 using their respective credit limit values and updated account statuses. The credit value generation unit 15 is connected to a credit value storage unit 17, which, in turn, is used as a buffer for storing the current credit values of the individual subscribers.

The tariff database 3 is connected to the input of a calculation unit 19 for calculating the estimated cost values of services requested by the subscriber on the basis of the stored communication network tariff data. A comparison unit 21 is connected to both the credit value storage unit 17 and the calculation unit 19 to compare the calculated estimated cost values with the current credit values and to emit an appropriate verification signal. Finally a service control unit 23 is connected to the output of the comparison unit 21 to trigger or block the requested service in response to the result of the comparison of estimated cost value and credit value.

A further account server 25 of a superimposed prepaid charge system is also connected to the account server 7 of the conventional accounting system, by means of which the account status for the account of the respective subscriber can be increased or recharged by electronic transfer of a corresponding credit almost in real-time. Every such change is noted in the account status database 9 and recorded by the account status recording unit 11 and the components credit limit value storage unit 13 and residual balance calculation unit 14 provide a correspondingly amended credit value, which is fed to the comparison unit 21 and will usually result in a positive verification signal being emitted by the latter and, therefore, to the triggering of the service provision.

The described method and apparatus do not take the route of improving the accounting process gradually by accelerating balance calculation with simultaneously increasing costs. Instead, a specific operating method also referred to above as the real-time payment process, (RT payment process) is superimposed on the existing accounting process, which does not reduce the risk gradually, but, in principle, eliminates it. This new process is based on the processes used at present in what are known as prepaid systems. In these systems, before the chargeable service is provided (e.g., setting up a connection), the current budget is verified and the service is only provided if the result of the verification is positive. There is therefore no longer a payment risk. Continuous verification of the current residual budget ensures that the budget cannot be exceeded.

With respect to what are known as contract customers with subsequent billing for services already used, the above-disclosed method checks the discretionary limit before providing any new service. The risk over and above the agreed discretionary limit is therefore not minimized by applying a limit to the value of possible transactions within any short period but is eliminated, in principle, by reversing the sub-stages.

Selective application of the significant process depending on the situation (conventional accounting process or RT payment process) both maximizes risk control and minimizes resulting costs. The established accounting system can continue to exist without shortening the update cycles, including all customer data. This means there is no migration cost and most importantly no migration risk.

An appropriate control system means that the RT payment process is only activated when the billing status of a customer is near to the customer's individual discretionary limit. An additional threshold (risk limit) is defined for this and specified for each customer.

If the unpaid balance is reduced by collection of a payment, the conventional accounting method can be resumed. There are, therefore, only a few customers in the RT payment process and these are only there temporarily.

As not all an operator's invoices are produced at the end of the month, but the invoice runs for all customers are spread over the month, use of the RT payment system can be expected to be evenly spread. In other words, only a relatively low capacity is required for its operation in relation to the total number of customers. This reduces the initial investment compared with known solutions.

Analysis of customer histories (e.g. in a CRM application) shows those customers, for whom there is a payment risk and from which level this should be subject to a special control procedure. In an additional process stage, in the context of account updates or billing in the conventional accounting system, these risk limits are then compared with current balances and where necessary temporary processing by means of the RT payment system is initiated or terminated.

In the case of mobile telephone networks (GSM) this can be done by resetting the service class mark flags in the HLR and setting up or deleting the customer in the SCP. In the case of fixed networks, line-based triggers have to be set up in the SSPs for all connections and then deactivated. A customer is then transferred into the RT payment system or back out of it by setting up the customer data and activating the trigger.

With this transfer to the RT payment system the account status of the last invoice run and also, if this takes place at a date which does not correspond to that of the invoice run, all usage data occurring since then must be transferred and the customer data initialized with the current account status calculated from it.

In this process the sub-stages must undergo a transaction control and take place in an appropriate sequence, so that a record of all usage incidents can be guaranteed.

The recording of transactions on the RT payment system then includes verification of the respective limits for each transaction, as described above, the updating of account status and the generation of data for the initial accounting system to avoid double charging. The original network element tickets can then be deleted.

The next invoice run then continues on the initial accounting system. The online balance on the RT payment system is at first only used for approving or rejecting usage requests from customers.

Depending on the detailed solution, the new sub-process of account monitoring can be installed as an additional sub-process. This means that charges continue to be recorded in the same way and this record continues to be the basis for billing.

Alternatively however this new sub-process can also replace charge calculation. This means that the network element records are rejected (e.g., at the filter/correlate substage). The billing sub-process then has recourse to the data and account status from the RT system for the period in question. The setting up and deletion of data structures for each customer can then be controlled by a separate process.

There may be customers whose accounts are regularly processed at the end of the month by means of the RT payment system, so it is expedient to avoid inputting and deleting their customer data. It may also be expedient to migrate individual customers permanently to the RT payment system.

Although preferred examples have been disclosed for illustrated purposes, those of ordinary skill in the art will appreciate that the scope of this patent is not limited thereto. On the contrary, this patent covers all methods and apparatus found within the scope of the appended claims.

What is claimed is:

1. An operating method for a communication network for providing a chargeable service to a subscriber via a network connection assigned to the subscriber, wherein service costs are subsequently billed through use of a collective invoice produced for a specific period of service usage at the network connection, the invoice covering a number of individual services, the method comprising:
receiving a record sent via a communication terminal connected to the network connection that specifies a selected service;
calculating an estimated cost value based on pre-stored tariff data in response to receiving the record;
comparing the estimated cost with a credit value;
issuing a verification signal that signifies a result of comparing the estimated cost with the credit value; and
at least one of blocking and triggering provision of the selected service in response to the verification signal.

2. An operating method as defined in claim 1, further comprising:
verifying whether the credit value exists for the network connection in response to the receipt of the record and triggering provision of the selected service immediately when the credit value does not exist for the network connection.

3. An operating method as defined in claim 1 wherein the credit value represents an absolute monetary sum.

4. An operating method as defined in claim 1 wherein the credit value represents a fixed residual balance of a pre-defined credit limit and is generated as soon as the credit limit is used up except for the residual balance by usage of services via the network connection or the network address.

5. An operating method as defined in claim 1 wherein a service with costs based on chargeable time or data quantities is subdivided into sub-services, wherein separate cost values can be assigned to each of the sub-services.

6. An operating method as defined in claim 1, wherein a message signifying a negative comparison result is sent to the communication terminal when a blockage of provision of the service occurs.

7. An operating method as defined in claim 1 wherein the communication network is configured as a fixed telephone network or mobile telephone network and the communication terminal is configured as a telecommunication terminal.

8. An operating method as defined in claim 1 wherein those network connections, for which an estimated cost value is generated, are assigned a prepaid charging arrangement account, which can be recharged electronically by the subscriber.

9. An operating method as defined in claim 8, wherein the prepaid charging arrangement account can be accessed for recharging via the communication network.

10. An operating method as defined in claim 1 wherein a switch is carried out to an operating mode from an accounting operation based on the subsequent production of collective invoices, when the value falls below the credit value.

11. An apparatus for implementing the operating method according to claim 1, the apparatus comprising:
an accounting control unit configured to switch from an accounting system based on the production of collective invoices to the operating method when the credit value is exceeded.

12. An apparatus for providing a chargeable service to a subscriber of a communication network via a network connection assigned to the subscriber, the apparatus comprising:
a calculation unit configured to calculate an estimated cost value, the calculation unit connected to a tariff database configured to store communication network tariff data;
a credit value storage unit configured to store a credit value assigned to the network connection;
a comparison unit connected to the calculation unit and the credit value storage unit, the comparison unit configured to compare the estimated cost value with the credit value and to emit a verification signal as a result of the comparison; and
a service control unit connected to an output of the comparison unit and configured to one of trigger or block the chargeable service based on a corresponding status of the verification signal, the chargeable service being assigned to a service control center.

13. An apparatus as defined in claim 12, further comprising:
a credit limit storage unit configured to store a credit limit corresponding to the network connection;
an account status recording unit configured to receive updated account status information concerning the network connection;
a residual balance calculation unit connected to the credit limit storage unit and the account status recording unit and configured to calculate a residual balance based on the credit limit and updated account status information; and
a credit value generation unit configured to calculate the credit value based on the residual balance.

14. An apparatus as defined in claim 12, wherein the communication network is configured as a fixed telephone network or a mobile telephone network and the apparatus is implemented in service control points of a relevant network connection.

15. An apparatus as defined in claim 12 further comprising:
at least one account server configured to control an accounting system with subsequent billing, and a prepaid charge arrangement, in which the at least one account server includes at least one account status storage unit.
